(19) United States
(12) Patent Application Publication
(10) Pub. No.: US 2006/0021284 A1
(43) Pub. Date: Feb. 2, 2006

(54) Refrigerator with a door-opening aid

(75) Inventor: Thomas Benz, Neu-Ulm (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 11/023,948

(22) Filed: Dec. 28, 2004

Related U.S. Application Data
(63) Continuation of application No. PCT/EP03/07344, filed on Jul. 8, 2003.

(30) Foreign Application Priority Data
Jul. 8, 2002 (DE) 102 30 707.5

(51) Int. Cl. E06B 7/16; E06B 7/18

(52) U.S. Cl. 49/477.1; 49/478.1; 49/475.1

(57) ABSTRACT

A refrigerator including a door that is fastened to the heat-insulating housing thereof and a swell chamber as a door-opening aid. The chamber can be impinged upon by a pressure medium and is disposed between the rear side of the door and a face of the housing. A reservoir feeding the swell chamber with a pressure fluid is disposed on a face of the door and can be compressed by pulling a door handle.

### CROSS-REFERENCE TO RELATED APPLICATION

This is a continuing application, under 35 U.S.C. § 120, of copending international application No. PCT/EP2003/007344, filed Jul. 8, 2003, which designated the United States; this application also claims the priority, under 35 U.S.C. § 119, of German patent application No. 102 30 707.5, filed Jul. 8, 2002; the prior applications are herewith incorporated by reference in their entirety.

### BACKGROUND OF THE INVENTION

1. Field of the Invention

The present invention relates to a refrigerator having a heat-insulating housing and a door mounted on the housing, the door being provided with a door-opening aid.

It has become common practice in the case of refrigerators, in particular, in the case of refrigerators provided with large-surface-area doors, to provide the doors with door-opening aids to make them easier to open. Such door-opening aids operate by converting a tensile force to which the door is subjected by the user into a displacement force that acts between the rear side of the door and the front side of the housing.

Such a refrigerator with the door-opening aid is disclosed, for example, in European Patent 0 891 524 B1.

This prior art door-opening aid is formed by a two-armed lever that is articulated on a side flank of the door, a first longer arm of the lever serving as the door handle and a second shorter arm being pressed against the front side of the housing when the door handle is pulled, and, thus, displacing the door away from the housing.

One problem with this known door-opening aid is that, for precise guidance of the pivoting movement of the door handle, it is necessary to provide guide rails that have to be installed on the lateral flank of the door of the refrigerator, projecting away from this flank, between the flank and the door handle. Such a configuration results in the door handle projecting laterally to a considerable extent beyond the door. If the door handle also projects laterally beyond the housing of the refrigerator, this gives rise to problems with setting the refrigerator up in the immediate vicinity of kitchen units or other appliances. In particular, it is not possible for two refrigerators that are disclosed in European Patent 0 891 524 B1 to be set up directly one beside the other.

The problem of lateral projection could easily be solved if a force-transmitting element could be guided through a bore in the door. This is not practicable, however, because such a bore would interrupt the continuity of the door leaf and would create a heat bridge. The production outlay would also be considerable. This can only be avoided if the force exerted by the user is directed laterally around the door, as is the case in European Patent 0 891 524.

Although it should be possible, in the case of a known refrigerator, to avoid the lateral projection of the door handle by the making the door narrower, while maintaining the same outer dimensions of the housing, such a measure also decreases the surface area on the front side of the appliance housing that can be covered by the door and, thus, the useful volume that the refrigerator can have.

Another possibility would, indeed, be to provide the lateral flank of the door with a niche and to fit the door handle in this niche, but such a configuration would result in a considerable increase in the outlay for producing the door and, thus, in rising costs.

### SUMMARY OF THE INVENTION

It is accordingly an object of the invention to provide a refrigerator with a door-opening aid that overcomes the hereinafore-mentioned disadvantages of the heretofore-known devices of this general type and that in which the door-opening aid has a novel functioning principle and that allows a force to which the front side of the door is subjected by the user to be transmitted to the rear side of the door with minimal lateral projection of the force-transmitting elements.

With the foregoing and other objects in view, there is provided, in accordance with the invention, a refrigerator, including a heat-insulating housing having a front side, a door mounted on the housing, the door having a rear side, and at least one swelling element to be subjected to action of a pressure medium disposed between the rear side of the door and the front side of the housing.

In accordance with another feature of the invention, the door has a door-mounting side and other sides and the swelling element is provided outside the door-mounting side on one of the other sides of the door.

In accordance with a further feature of the invention, the swelling element occupies a longitudinal portion of the one of the other sides.

The swelling element of such a refrigerator may be constructed as a cylinder/piston configuration. It is particularly straightforward and inexpensive, and sufficient for the small amount of displacement required, however, if the swelling element is constructed as a bag or pad with flexible walls, the thickness of this bag or pad varying depending on the quantity of pressure medium located in the swelling element. The swelling element expediently communicates with a compressible reservoir for the pressure medium. It is, thus, possible to provide a closed system in which the pressure medium, when the door-opening aid is used, is displaced out of the reservoir into the swelling element and, following this, returns into the reservoir. By virtue of the seal being lifted off with the aid of the swelling element, it is also the case, namely, in the region of the swelling element, at the same time, that not just the negative pressure that may be present is overcome, but also the force of attraction acting on the housing from the magnet of the magnetic door seal is overcome. The partial lifting off of the magnetic seal, then, gives rise, during the subsequent opening of the door, to a kind of “peeling-off effect” of the magnetic seal from the housing. As a result, the force for opening the door is further reduced.

In accordance with an added feature of the invention, the swelling element occupies a part of a longitudinal portion of the other sides of the door.

In accordance with an additional feature of the invention, there is provided a door handle secured on the door and having a height region and the part of the longitudinal portion is disposed within the height region.

In accordance with yet another feature of the invention, the swelling element has at least one flexible wall interacting with the front side of the housing.

Whereas the swelling element is fitted between the front side of the housing and the rear side of the door, it is possible for the reservoir to be fitted on the front side of the door and to communicate therewith through a channel that extends over the surface of a housing panel of the door, also over the lateral flank of the door. It is possible for the extent of the channel in the width direction of the door, level with the lateral flank, to be very small, that is to say, the lateral projection of the channel beyond the housing can also be avoided when the width of the door is only insignificantly smaller than that of the housing.

For protecting the channel, the channel expediently is covered over by a plate, e.g., made of a strong plastic or, preferably, metal.

To subject the reservoir to pressure, a door handle is expediently configured as a lever that can be pivoted about an axis and has a handgrip and a portion acting on the reservoir. In such a case, the handgrip and the portion acting on the reservoir are located, preferably, opposite one another on different sides of the axis. As a result, it is possible, by pulling the handgrip away from the door, to compress the reservoir between the portion of the door handle and the front side of the door.

Preferably, the axis is vertical because, in the case where a user does not have his/her hands free, such a configuration makes it easier for him/her to actuate the door handle using a shoulder or elbow.

This process of actuation is facilitated additionally if the handgrip is further remote from the mounting side of the door than the axis of the lever.

It is known per se to fit a sealing profile, generally in the form of a magnetic profile, between the rear side of the door and the front side of the housing of a refrigerator. A cavity of such an encircling flexible sealing profile may serve, according to the invention, for accommodating the swelling element.

In order to facilitate the opening displacement, it is possible, in the case of a magnetic profile, for the swelling element expediently to be disposed on the inside of the magnetic strip.

With the objects of the invention in view, there is also provided a refrigerator, including a heat-insulating housing having a front side, a door having a rear side and a door-mounting side, the door being mounted on the housing at the door-mounting side, a door handle pivotably secured on the door, a compressible reservoir storing a pressure medium, the door handle having a portion compressing at least a part of the reservoir when the handle is actuated, and at least one swelling element subjected to action of the pressure medium, the swelling element being fluidically connected to the reservoir, being disposed between the rear side of the door and the front side of the housing, and having at least one flexible wall interacting with the front side of the housing.

Other features that are considered as characteristic for the invention are set forth in the appended claims.

Although the invention is illustrated and described herein as embodied in a refrigerator with a door-opening aid, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, cross-sectional view of a section of a door of a refrigerator with a door-opening aid according to the invention;

FIG. 2A is a diagrammatic elevational view of part of the door of FIG. 1 and of a housing of a refrigerator according to the invention;

FIG. 2B is a diagrammatic cross-sectional view of the door part of FIG. 2A along section line B-B in FIG. 2A;

FIG. 3 is a fragmentary, perspective view of a reservoir and a swelling element of the door-opening aid of FIG. 1, separately from the door;

FIG. 4 is a fragmentary, cross-sectional view through a sealing profile, a magnetic profile, and adjacent parts of the door according to the invention and of the housing of a refrigerator in a closed state of the door; and

FIG. 5 a fragmentary, cross-sectional view through the parts of FIG. 4 in a displaced state.

### DESCRIPTION OF THE PREFERRED EMBODIMENTS

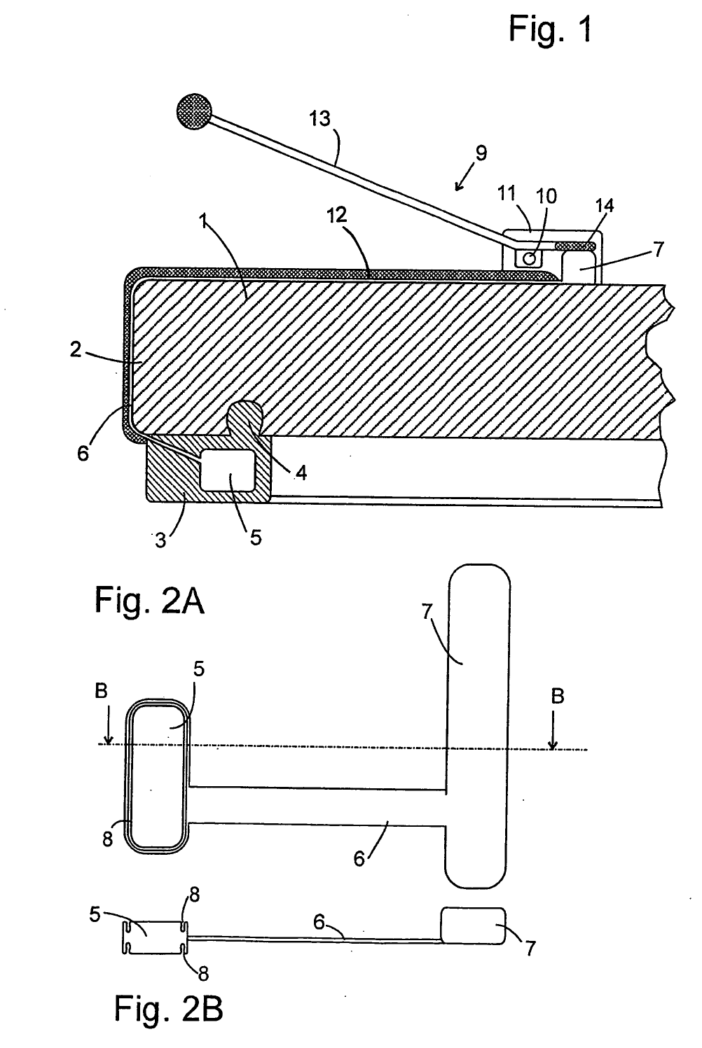

Referring now to the figures of the drawings in detail and first, particularly to FIG. 1 thereof, there is shown a simplified section through part of a door of a refrigerator provided with a door-opening aid according to the present invention. The door 1 is mounted, on a side that is directed away from its lateral flank 2 shown in FIG. 1, on a non-illustrated refrigerator housing. A flexible sealing profile 3 is fastened on the rear side of the door 1, the rear side being directed away from the housing, by virtue of an extension 4 of the sealing profile 3 being inserted into a groove that runs around the entire rear side of the door 1 in the vicinity of the periphery.

The door 1 is constructed in a manner that is known per se, and is, thus, not illustrated in more detail in FIG. 1, from an outer cladding, e.g., made of metal, an inner cladding, e.g., made of plastic, which is directed toward the housing and is adjacent to the outer cladding in the vicinity of the groove, and a heat-insulation material, which fills a cavity formed between the outer housing panel and the inner wall.

The cross-section of FIG. 1 shows, in the interior of the sealing profile 3, a swelling element 5 that extends over a few centimeters in the vertical direction, perpendicular to the sectional plane of FIG. 1, along the longitudinal plane located opposite the mounting side of the door 1. The overall height of the swelling element 5, thus, only occupies a small portion of the length of the door 1. The swelling element 5 is connected, through a channel 6, to a reservoir 7 provided on the front side of the door 1. The channel 6 runs along a part or front side of the door 1 and over the lateral flank 2, beneath a plate 12 made of a strong, tough plastic or of a metal, e.g., aluminum, which protects the channel 6 against damage.

FIG. 2A is a side view of the swelling element 5, the channel 6, and the reservoir 7, shown separate from the door 1 on which these are installed. The swelling element 5, channel 6, and reservoir 7 are connected integrally to one another throughout; they are of a plastic material that is flexible, but does not expand to any significant extent. They may be produced, for example, by virtue of two blanks with the outline shown in FIG. 2A being created from flat plastic material and welded along their peripheries, a final welding step for definitive sealing purposes being carried out only following introduction of a pressure fluid, e.g., a brine or a water/alcohol mixture.

FIG. 2B shows a section through the swelling element 5, the channel 6, and the reservoir 7 along a section line B-B in FIG. 2A. The channel 6 has a markedly elongate cross-section in the vertical direction. This is necessary in order, on one hand, to have a cross-sectional surface area of the channel 6 that is sufficient for the quick exchange of pressure fluid between the reservoir 7 and swelling element 5 and, on the other hand, to minimize the lateral projection of the channel 6 beyond the flank 2. A second function of the plate 12, in addition to its protective function, is, thus, to prevent the cross-section of the channel 6 from spreading when its internal pressure increases as a result of compression of the reservoir 7 and, thus, to ensure that pressure fluid forced out of the reservoir 7 reaches the swelling element 5.

It is possible to see passages 8 that run around the top side and underside of the swelling element 5 and promote an increase in size of the swelling element 5 in the vertical direction of FIG. 2B when the reservoir 7 is subjected to pressure and pressure fluid flows from there into the swelling element 5. Such an increase in size of the swelling element causes the sealing profile 3 to become thicker in the vertical direction of FIG. 1, that is to say, causes the door and housing of the refrigerator to be displaced away from one another over a portion of the sealing profile 3 that corresponds to the vertical extent of the swelling element 5. By virtue of the sealing profile 3 becoming locally thicker in this way, it is displaced away from the housing of the refrigerator in the region adjacent to the swelling element 5. The sealing profile 3, thus, no longer provides a sealing function, a negative pressure that may prevail in the interior of the appliance is eliminated, and the door 1 can be easily opened.

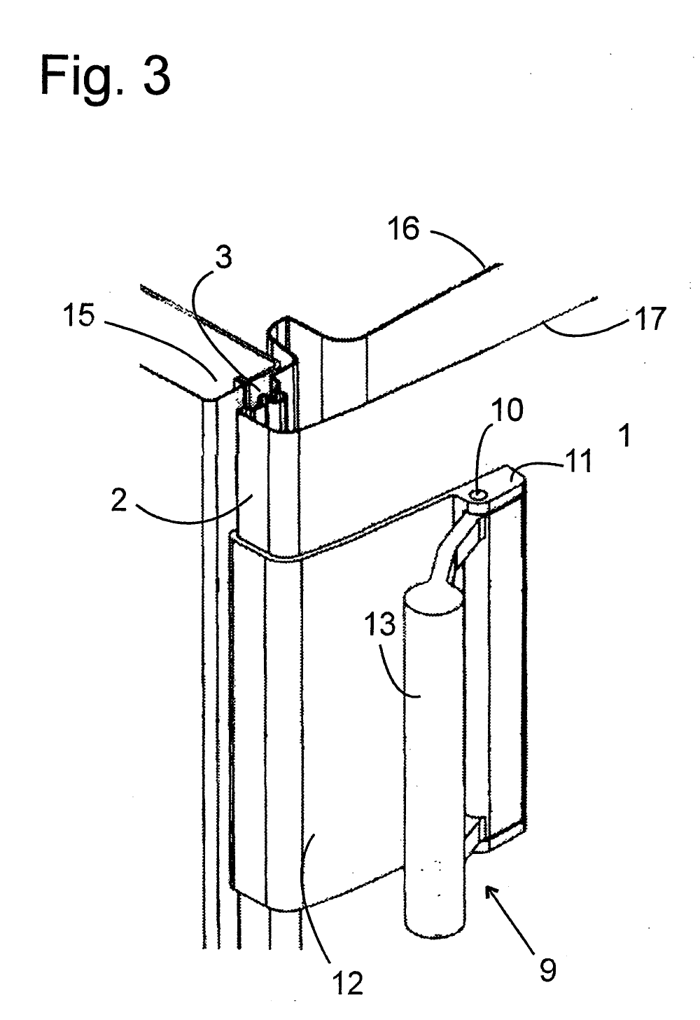

To compress the reservoir 7, a door handle 9 is articulated on the front side of the door 1 such that it can be pivoted about a vertical axis 10. As can clearly be seen in FIG. 3, in particular, the axis 10 is defined by bores in two lugs 11 that project forward from the plate 12, which covers over the channel 6. The door handle 9 is configured as a two-armed lever—a first lever arm, which projects obliquely forward from the axis 10, forming a hand grip 13 and the second lever arm 14 keeping the reservoir 7 pressed against the outer wall of the door 1. By pulling the hand grip 13 forward (upward as viewed in FIG. 1), a user subjects the reservoir 7 to pressure. As a result, the door 1 is displaced away from the housing of the refrigerator by pressure fluid flowing from the reservoir 7 into the swelling element 5.

The plate 12 and the door handle 9 are symmetrical in relation to a horizontal plane. By virtue of the peripheries of the plate 12 being adhesively bonded to the door 1, the door handle can be installed both on the right-hand side and on the left-hand side of the door 1. As a result, the user can decide as to whether the door 1 is mounted on the left or right of the housing.

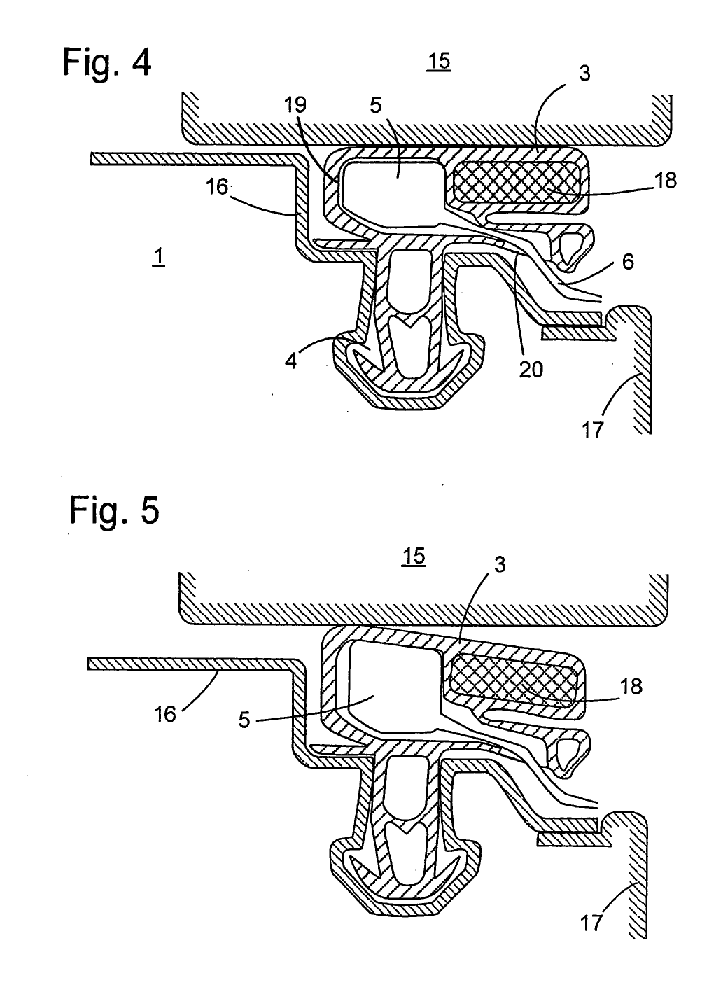

FIG. 4 shows a section through mutually opposite regions of the door 1 and of a side wall 15 of the refrigerator housing according to a preferred configuration of the invention. The abovementioned groove of the door 1 is formed in a plastic inner cladding 16 that forms the inside of the door 1; this inner cladding 16 is connected to an outer cladding, for example, by the foaming expansion of a heat-insulation material that is introduced in liquid starting components between the inner and the outer claddings.

The sealing profile 3 has an encircling chamber 18 that is filled with magnetic material. As a result, the door 1 is kept closed by magnetic forces acting between this material and metal of the side wall 15.

The chamber 18 extends only over part of the width of the sealing profile 3; located parallel to it, in the direction of the interior of the refrigerator, is a second chamber 19, in which the swelling element 5 is accommodated. The chamber 19 opens out into the surroundings through a slot 20, through which the channel 6 extends. Rather than running over the entire length of the sealing profile 3, the slot 20 expediently runs, in a height provided for fitting the door handle, merely over a length that is sufficient to introduce the swelling element 5 into the chamber 19. The swelling element 5, which is associated with the location where the door handle 9 is fitted, is either of the same height as this door handle 9 or of a height that is smaller than the height of the door handle 9.

FIG. 5 shows the same section as for FIG. 4, albeit with the swelling element 5 in an expanded state. The chamber 18 with the magnetic material has been lifted from the front side of the side wall 16. As a result, magnetic forces acting between the material and the side wall are reduced to a considerable extent. It is also the case, above and beneath the swelling element 5, that the sealed abutment of the profile 3 against the side wall 15 has been eliminated. Thus, the door can be readily opened in this state.

Because the channel 6, which connects the swelling element 5 to the reservoir 7, and the plate 12, which covers the channel 6 over, can be kept very flat, the above-described door-opening aid only requires minimal lateral projection beyond the door 1 and, thus, does not obstruct a number of refrigerators from being set up directly adjacent to one another or a refrigerator from being set up in direct lateral contact with other units.

In contrast to the exemplary embodiment described, provision may be made for the swelling element 5 to be disposed not on the side of the door 1 that is located opposite the door-mounting side but on one of the other door sides. Moreover, provision may also be made for the swelling element 5 to be provided outside the door-mounting side at a number of locations of the other door sides or else, for example, for one swelling element to be provided on each of the other door sides.

I claim:

1. A refrigerator, comprising:
a heat-insulating housing having a front side;
a door mounted on said housing, said door having a rear side; and
at least one swelling element to be subjected to action of a pressure medium disposed between said rear side of said door and said front side of said housing.

2. The refrigerator according to claim 1, wherein:
said door has a door-mounting side and other sides; and
said swelling element is provided outside said door-mounting side on one of said other sides of said door.

3. The refrigerator according to claim 2, wherein said swelling element occupies a longitudinal portion of said one of said other sides.

4. The refrigerator according to claim 1, wherein:
said door has a door-mounting side and other sides; and
said swelling element occupies a part of a longitudinal portion of said other sides of said door.

5. The refrigerator according to claim 3, wherein said swelling element occupies a part of said longitudinal portion.

6. The refrigerator according to claim 4, further comprising:
a door handle secured on said door and having a height region; and
said part of said longitudinal portion is disposed within said height region.

7. The refrigerator according to claim 5, further comprising:
a door handle secured on said door and having a height region; and
said part of said longitudinal portion is disposed within said height region.

8. The refrigerator according to claim 1, wherein said swelling element has at least one flexible wall interacting with said front side of said housing.

9. The refrigerator according to claim 1, wherein said swelling element is one of a bag and a pad having flexible walls.

10. The refrigerator according to claim 1, further comprising:
a compressible reservoir for storing the pressure medium; and
said swelling element fluidically communicating with said compressible reservoir.

11. The refrigerator according to claim 6, wherein said door handle is a lever pivoted about an axis and has a hand grip and a portion acting on said reservoir.

12. The refrigerator according to claim 7, wherein said door handle is a lever pivoted about an axis and has a hand grip and a portion acting on said reservoir.

13. The refrigerator according to claim 10, further comprising a door handle secured on said door, said door handle being a lever pivoted about an axis and having a hand grip and a portion acting on said reservoir.

14. The refrigerator according to claim 11, wherein said axis is vertical.

15. The refrigerator according to claim 12, wherein said axis is vertical.

16. The refrigerator according to claim 13, wherein said axis is vertical.

17. The refrigerator according to claim 11, wherein said handgrip is shaped to compress said reservoir by pulling said handgrip.

18. The refrigerator according to claim 12, wherein said handgrip is shaped to compress said reservoir by pulling said handgrip.

19. The refrigerator according to claim 13, wherein said handgrip is shaped to compress said reservoir by pulling said handgrip.

20. The refrigerator according to claim 11, wherein said handgrip is further remote from said door-mounting side than said axis of said lever.

21. The refrigerator according to claim 12, wherein:
said door has a door-mounting side; and
said hand grip is further remote from said door-mounting side than said axis of said lever.

22. The refrigerator according to claim 13, wherein:
said door has a door-mounting side; and
said hand grip is further remote from said door-mounting side than said axis of said lever.

23. The refrigerator according to claim 10, wherein:
said door has a front side and a housing panel with a surface;
said reservoir is disposed on said front side of said door;
a channel extends over said surface of said housing panel; and
said front side of said door is directed away from said housing and is connected to said swelling element through said channel.

24. The refrigerator according to claim 23, further comprising a plate covering said channel.

25. The refrigerator according to claim 24, wherein:
said door has a door-mounting side and other sides;
said swelling element occupies a part of a longitudinal portion of said other sides of said door;
a door handle is secured on said door and is a lever pivoted about an axis; and
said axis is anchored on said plate.

26. The refrigerator according to claim 1, further comprising:
an encircling flexible sealing profile fitted between said rear side of said door and said front side of said housing and having a cavity; and
said swelling element being fitted in said cavity.

27. The refrigerator according to claim 26, wherein:
said sealing profile has a strip of a magnetic material;
said strip has an inside; and
said swelling element is disposed on said inside of said strip.

28. A refrigerator, comprising:
a heat-insulating housing having a front side;
a door having a rear side and a door-mounting side, said door being mounted on said housing at said door-mounting side;
a door handle pivotably secured on said door;
a compressible reservoir storing a pressure medium, said door handle having a portion compressing at least a part of said reservoir when said handle is actuated; and
at least one swelling element subjected to action of said pressure medium, said swelling element:
being fluidically connected to said reservoir;
being disposed between said rear side of said door and said front side of said housing; and
having at least one flexible wall interacting with said front side of said housing.

29. The refrigerator according to claim 28, wherein:
said door has a front side and a housing panel with a surface;
said reservoir is disposed on said front side of said door;
a channel extends over said surface of said housing panel; and
said front side of said door is directed away from said housing and is connected to said swelling element through said channel.
